(19) United States
(12) Patent Application Publication
(10) Pub. No.: US 2026/0206791 A1
(43) Pub. Date: Jul. 23, 2026

(54) PACKED TEXTURIZED PROTEIN UNITS AND USES THEREOF

(71) Applicant: REDEFINE MEAT LTD., Rehovot (IL)

(72) Inventors: Daniel Mandelik, Rehovot (IL); Daniel Dikovsky, Ariel (IL)

(21) Appl. No.: 19/567,593

(22) Filed: Mar. 16, 2026

Related U.S. Application Data
(62) Division of application No. 17/913,249, filed on Mar. 24, 2021.

(30) Foreign Application Priority Data
Mar. 24, 2020 (IL) 273546

(51) Int. Cl. A23J 3/22; A23J 3/14; A23P 20/20; A23P 20/25; B33Y 10/00; B33Y 70/00; B65D 83/08; B65D 85/62

(52) U.S. Cl. CPC A23J 3/227; A23J 3/14; A23P 20/20; B33Y 10/00; B33Y 70/00; B65D 83/08; B65D 85/62; A23P 2020/253

(57) ABSTRACT

The present disclosure provides a single or a set of packed protein unit for use in fabrication of a meat analogue product, the packed protein unit comprises at least one elongated texturized protein strip held, in an organized spatial configuration, by or within a retaining element, the at least one elongated texturized protein strip being defined by a longitudinal axis and a cross sectional area taken perpendicular to the longitudinal axis; wherein at least one dimension of said cross sectional area is equal or less than 10 mm and said longitudinal axis has a dimension of at least 100 mm. Also disclosed herein is a method of fabricating a meat analogue product making use of one or more packed protein units disclosed herein.

### TECHNOLOGICAL FIELD

The present disclosure relates to food technology and specifically to packed protein material for use in the food industry.

### BACKGROUND ART

References considered to be relevant as background to the presently disclosed subject matter are listed below:
International Patent Application Publication No. WO20152689
US Patent Application Publication No. 2006210675

Acknowledgement of the above references herein is not to be inferred as meaning that these are in any way relevant to the patentability of the presently disclosed subject matter.

### BACKGROUND

Manufacturing of whole cut meat analogues requires an organized assembly of texturized protein.

WO20152689 describes the fabrication of a meat analogue that comprises a protein-based component and a fat-based component separately distributed within the meat analogue. The alignment of the protein material in the meat analogue is obtained using extrusion techniques.

### GENERAL DESCRIPTION

The herein disclosed technology aims at providing pre-packed protein material for use in the fabrication of meat analogue products in a mechanism that serves as an alternative or complementary to printing, dispensing or otherwise depositing of viscous protein material.

To obtain a satisfactory whole muscle cut alt-meat it is required that the protein matter therein have a specific texture, and this can be achieved, inter alia, by using protein matter with a defined material orientation, as opposed to minced alt-meats.

The herein disclosed technology is based on the principle of ‘off-line’ preparation of elongated strips (e.g. strands) of an essentially solid, already texturized protein material and packing the elongated strips in a manner that allows its placement onto a printing bed in a manner forming layer(s) of the protein material according to a desired pattern.

Thus, in accordance with a first of its aspects, the present disclosure provides packed protein unit comprising at least one texturized protein strip held, in an organized spatial configuration, by or within a retaining element, the at least one elongated texturized protein strip being defined by a longitudinal axis and a cross sectional area taken perpendicular to the longitudinal axis;
wherein at least one dimension of said cross sectional area is equal or less than 10 mm and said longitudinal axis has a dimension of at least 100 mm.

The packed protein unit is preferably for use in fabrication of a meat analogue product.

In accordance with a further aspect, the present disclosure provides a set of packed protein units, each unit comprises at least one elongated texturized protein strip held, in an organized spatial configuration, by or within a retaining element, the at least one elongated texturized protein strip being defined by a longitudinal axis and a cross sectional area taken perpendicular to the longitudinal axis, wherein at least one dimension of said cross sectional area is equal or less than 10 mm and said longitudinal axis has a dimension of at least 100 mm; and wherein at least one elongated texturized protein strip within at least some of the units of the set is different from at least one other texturized protein strip within other units of the same set.

The present disclosure also provides, in accordance with a further aspect, a method of fabricating an edible food product, preferably a meat analogue product, the method comprises providing at least one packed protein unit comprising one or more elongated texturized protein strips held, in an organized spatial configuration, by or within a retaining element; and releasing onto a food fabrication bed one or more of said elongated texturized protein strips from said packed protein unit to form one or more monolayers of texturized protein strands; wherein the at least one elongated texturized protein strip is defined by a longitudinal axis and a cross sectional area taken perpendicular to the longitudinal axis, at least one dimension of said cross sectional area is equal or less than 10 mm and said longitudinal axis has a dimension of at least 100 mm; and wherein said release is in a manner to cause, in a monolayer, alignment along a predefined direction of at least 60% of the plurality of elongated texturized protein strips; and wherein said release of the one or more elongated texturized protein strips is in a manner to form on the food fabrication bed a multi-layered edible food product, preferably meat analogue product, where each layer is being created essentially one on top of the other.

### BRIEF DESCRIPTION OF THE DRAWINGS

In order to better understand the subject matter that is disclosed herein and to exemplify how it may be carried out in practice, embodiments will now be described, by way of non-limiting example only, with reference to the accompanying drawings, in which:

FIG. 1 provides a schematic illustration of a cross sectional isometric view of packed protein material in accordance with one example of the present disclosure.

FIGS. 2A-2B provide schematic illustrations of cross section views of two differently packed protein material in accordance with some other examples of the present disclosure.

FIGS. 3A-3D provide schematic illustration of packed protein material where the texturized protein is in sheet-like form (FIG. 3A), each sheet like structure is comprised of units of texturized protein material in a form of short strands (FIG. 3B) or elongated strands (FIG. 3C), and the sheet like structures can be stacked one on top of the other (FIG. 3D) to form a texturized protein unit.

FIG. 4 provides a schematic illustration of packed protein material being in a form of an elongated strand arranged in a convoluted configuration, in accordance with another example of the present disclosure.

FIG. 5 provides a schematic illustration of a packed protein material in a spirally wound configuration and some elements of a digital printer, the packed protein being in accordance with yet another example of the present disclosure.

FIGS. 6A-6B provides packed protein material being in a form of an elongated strand spirally wound around a central body having a shape of a spool, the strand being narrow (FIG. 6A) or being wide (FIG. 6B).

FIGS. 7A-7D provide images of exemplary texturized protein strands in accordance with an example of the present disclosure, FIGS. 7A-7B providing individual elongated strands and their dimensions, FIG. 7C providing an image of a strand's cross section and its internal morphology; and FIG. 7D providing a rolled elongated strand, and b providing an image of the strands cross-sectional cut, and its porous morphology.

### DETAILED DESCRIPTION

The present disclosure relates to pre-packed texturized protein material for use in the formation of food products and particularly although not exclusively for meat analogues.

The present disclosure is based on the understanding that protein-based food products, and particularly meat analogues prepared by additive manufacturing techniques, such as, however, without being limited thereto, digital printing, require the use of a protein rich dough/paste that is, on the one hand, viscous enough to retain the shape of the meat analogue product after being formed (i.e. support itself and the forthcoming additional deposited layers) and on the other hand be sufficiently flowable, i.e. be in a physical state which allows its flow through a narrow printing nozzle. Yet, when trying to dispense such viscous protein dough using 3D printing techniques, an alternative was envisaged, the alternative being based on pre-formed texturized protein strips. Such pre-formed texturized protein-based strips can be packed in a manner suitable for later use by the particular food manufacturer. In one preferred embodiment, the packed protein strips are packed in a manner suitable for use in the meat analogue industry.

Thus, in accordance with a first of its aspects, the present disclosure provides a packed protein unit comprising elongated texturized protein strips held, in an organized spatial configuration, by or within a retaining element, the at least one elongated texturized protein strip being defined by a longitudinal axis and a cross sectional area taken perpendicular to the longitudinal axis; wherein at least one dimension of said cross sectional area is equal or less than 10 mm and said longitudinal axis has a dimension of at least 100 mm. The packed protein unit is preferably for use in fabricating food products, preferably meat analogues.

When the unit comprises more than one strip, the plurality of strips are preferably arranged in a form of an organized collection of one or more separable texturized protein strips, as further discussed below.

In the context of the present disclosure, when referring to packed protein unit it is to be

understood as meaning texturized protein material that is maintained, typically in a pre-defined organized spatial arrangement, by or within a retaining element. The texturized protein material can be packed within a housing e.g. a container or cartridge and/or can be mounted onto a support body; the housing and the support body being collectively referred to herein as the “retaining element”.

The “retaining element” can have any shape and/or structure and can be made of any rigid or semi rigid material that permits the retention of the at least one texturized protein strip in its pre-determined organization/form. The retaining element can hold the elongated strip in any desired form, be it as a closed container enclosing the elongated strips or as a supporting body physically holding the strip(s) as further described below.

Further, in the context of the present disclosure, when referring to “organized spatial configuration” it is to be understood as any arrangement of the strip or strips that is other than arbitrary arrangement, and specifically, an arrangement that is a pre-determined, or pre-organized in a manner configured for of allowing ease of release of the strip or strips from the retainer.

In some examples, the strip is in a form of an elongated strand (fiber/filament/string). When referring to a strand it is to be understood to refer to the strip having essentially the same dimension in any direction along its cross section (taken perpendicular to the longitudinal axis). This may include, for example, an essentially circular cross section. Thus, according to this non-limiting example, the strip is an elongated strand/string.

In some other examples, the strip is flattened, e.g. in a form of a sheet.

The sheet can be defined by at least two dimensions of its cross section (perpendicular to the longitudinal axis), with one dimension being at least twice that of one other dimension.

In some examples, the packed protein unit comprises a plurality of texturized protein strips.

As defined herein, the longitudinal axis is at least 100 mm in length, at times 200 mm in length, at times, 250 mm, at times 300 mm in length, at times 400 mm in length or even at times 500 mm. In some examples, the longitudinal axis is between 100 mm and 500 mm, at times from between 150 mm and 1,000 mm, at times, between 100 mm and 1,000 mm or any range between 100 mm and 10 m.

With respect to the cross section of the strip, it is noted that it can have a generally curved circumference, e.g. essentially round, essentially oval, or a generally polygonal circumference, e.g. essentially square, rectangle, etc., even if the curvature line is amorphous. The strip will then be defined by dimensions of the cross-section.

The strip can, alternatively, or in addition, be defined by a two-dimension ratio, e.g. length to average cross section ratio, e.g. 500 mm strip of 2 mm diameter would have dimension ratio of 250.

In some examples, the strip is characterized by at least one cross sectional dimension within the range of 0.01 mm to 10 mm, at times, between 0.02 mm and 3 mm, at times, between 0.05 mm and 3 mm, at times, between 0.1 mm and 5 mm, at times, between 0.02 mm and 0.1 mm, at times, between 0.05 mm and 1 mm, at times between 0.75 mm and 2 mm.

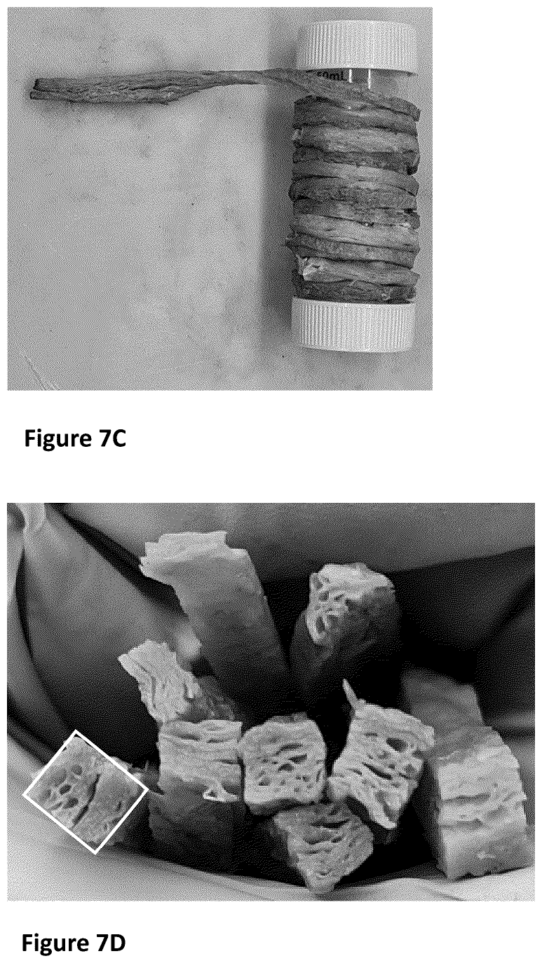

In some examples, the strips are characterized by their cross-sectional area (when the cross section is taken perpendicular to the longitudinal axis). The cross-sectional area is defined irrespective of whether the strip is porous or contains void. Thus, while a cross-sectional cut will typically present a spongy or porous strip, the cross-sectional area takes into consideration the entire area within the boundaries/contour of the cut. A cross sectional cut of exemplary strips and their spongy morphology is shown in FIG. 7D.

In some examples, the cross-sectional area is less than 100 mm², at times, less than 90 mm², at times, less than 80 mm², at times, less than 70 mm², at times, less than 60 mm², at times, less than 50 mm², at times, less than 40 mm², at times, less than 30 mm², at times, less than 20 mm², at times, less than 10 mm², at times, less than 8 mm², at times, less than 6 mm², at times, less than 4 mm². The strips can be prepared or obtained by various techniques.

In some examples, the strips are in a form of strands and the strands are obtained by extrusion.

In some examples the strips are in a form of strands which are obtained by using shear cell.

In some other examples, the strips are obtained by mechanical slicing of strips, either as strands or as elongated sheets.

In some examples, the strips are inter-connected to fix in place the strips, one with respect to the other. In one preferred example, the interconnected strips are essentially parallel to one another, along their longitudinal axis. The strips can be inter-connected using, for example, edible glue, film or fiber, which are then retained as a part of the food product; or the interconnection can be made of food packaging material that need to be removed prior to layering of the strips in the eventually formed food product.

In some examples, the packed protein unit comprises more than one texturized protein strips held together within a housing. In some examples, a unit of packed protein, e.g. a single housing comprises a plurality of elongated texturized protein strips stacked together in a manner where individual strips are parallelly oriented, along their longitudinal axis, one with respect to the other.

When referring to “parallel strips” or “parallelly oriented strips” it is to be understood to refer to the orientation of at least 80% of the strips, preferably 95% of the strips and preferably 99% of the strips, one with respect to the other when viewed within a portion of a layer such that their longitudinal axis, to be generally parallel. The term “generally parallel” should be understood to encompass the nominal direction of the longitudinal axis to be at most ±10°, at times, at most ±3°, at most ±1°.

In some examples, the plurality of strips within a housing is discrete and separable strips such that each strip is released from the cartridge as an individual strip.

In some other examples, the plurality of texturized protein strips are parallelly stacked one on top of another in a form of an monolayer of parallel strands within the housing and as such are releasable from the housing as individual layers, each layer comprising parallel strands.

In some other examples, the plurality of strips are retained in the housing as a set of stacked sheets.

Within a packed protein unit, the plurality of strips can, in principle, vary in their shape and/or composition and/or dimension.

Yet, in some preferred examples, a packed protein unit would comprise the same protein composition and, in some examples, the strips in a single a packed protein unit have the same at least essentially the same length along their longitudinal axis.

In some examples, a packed protein unit comprises a plurality of discrete texturized protein strips having an essentially identical dimension.

In some examples, the retaining element is in a form of a cartridge enclosing/carrying one or more elongated texturized protein strips.

In some examples, the retaining element is a cartridge holding one or more elongated strands, each being folded in a convoluted configuration. When referring to a “convoluted configuration” it is to be understood to encompass any spatial arrangement of the strand(s) that allow the smooth release of thereof from the cartridge, e.g. a spatial arrangement that knot-free.

In some examples, the convoluted configuration comprises a zig-zag configuration. In some other examples, the convoluted configuration comprises a spiral or coiled configuration.

In some examples, the retaining element is in a form of a cartridge, holding a plurality of discrete and separable strands or discrete and separable sheet-like strips in parallel orientation, one stacked on top of the other. The cartridge is configured to allow the individual and separate release/extraction/dispensing of each strip in a controlled manner. For example, the cartridge's opening is equipped with a controllable shutter, operable to release individual strips in a controlled rate and/or controlled direction/orientation.

In some examples, the retaining element is in a form of a central body, and the one or more elongated texturized protein strips are spirally wound around or rolled over said central body.

In some examples, the strips are elongated strands such that each unit comprises a central body having, rolled thereover, a single elongated texturized protein strand.

In some other examples, the strips are in the form of elongated sheets and each packed protein unit comprises a central body having, rolled thereover, a single elongated texturized protein sheet. In yet some other examples, the packed protein unit comprises a central body having, rolled thereover, a plurality of strands, interconnected one to each other in an essentially parallel orientation. When referring to interconnected strands, it can be visualized like a bamboo-mat, i.e. form a bamboo-like mat, with distances between neighboring strands. The distance between the strands can be essentially the same or different. In some cases, the distance between the strands is essentially the same. In some cases, the distance between the strands is such that there is essentially no physical contact between neighboring strands along their longitudinal axis.

In some examples, the central body has a form selected from spindle or cylinder with or without flanges, on which the elongated strip(s) is wound. At times, the central body resembles a bobbin or a spool.

In some examples, the central body has a curved circumference, e.g. circular, elliptical, or any other curvature that is preferably lacking angles that could damage/crack the strand wound around it.

The protein strips comprise texturized protein material.

In the context of the present disclosure, the term “texturized protein strip” is to be understood to mean that the strip, be it in a form of a strand or a sheet, comprises one or more bundles of texturized fibers, e.g. essentially axially aligned protein containing fibers; and that each bundle of texturized fibers comprises a structurally organized collection of protein based material, as further discussed below.

Further or alternatively, when referring to texturized protein strip it is to be understood as protein matter that is made via extrusion methods known in the art, e.g. for producing texturized vegetable protein (TVP) or other techniques, such as high moisture extrusion (HME).

The alignment can be obtained by various techniques. For example, by applying constant mechanical forces in a certain direction on a flowing protein material either by continuous pushing (e.g. as done during extrusion), continuous pulling (e.g. as done in spinning) and shearing (e.g. as done in a shear Couette cell).

The alignment techniques may utilize thermal effects (e.g. heating or cooling), chemical agents (e.g. enzymes) etc., for enhancing the anisotropic character of the resulting fibers.

In some examples, the essential alignment of the protein material within the strip is obtained by extrusion, such as hot extrusion or cold extrusion. Accordingly, the one or more texturized protein strips comprise protein extrudate.

In some other examples, the essential alignment of the protein is obtained by spinning, e.g. carried out using an electrospinning device. There are different approaches in spinning of proteins so as to texturize them, including, without being limited thereto, an enzymatic approach (typically to yield a gel like structure), a dehydration approach (typically to rigidify the protein material); a temperature approach (to affect flowability/solubility of the protein material); an anti-diluent approach (typically referred to as a wet spinning); pH approach (typically also to affect solubility of the protein material, for example, chitosan which is more soluble at weak acidic conditions).

The ability of a protein material to form into an elongated fiber is typically linked to its basic shape (rod-shaped/elongated structures can form a fiber much easier than globular ones). Further, proteins may require heating and/or high shear forces in order to prime them into forming a fibrous material. Therefore, in some examples, the protein material is combined with non-protein material for spinning processes.

In some examples, in order to facilitate the formation of essentially aligned fibers (not necessarily in spinning processes), the protein material can be combined with one or more polysaccharides. Without being limited thereto, such polysaccharides are water soluble or polymers that are soluble at specific pH. Such polymers include, without being limited thereto, Guam gum, Xanthan gum, k-Carrageenan, chitosan, cellulose, starch and lignin.

In the context of the present disclosure, the term “essentially” is to be understood to also include some level of deviation (e.g. 1%, 2%, 3%, 10% or even up to 20%) from the defined parameter.

The term “essentially axially aligned fibers” as used herein refers to a fibrous or sheet-like texturized protein in which the protein fibers therein have a nominal direction that is essentially to the same as that of the direction of the longitudinal axis of the strip.

The term “nominal direction” as used herein refers to a direction where significantly more than 50% of the fibers within the strand have a direction of up-to ±45 degrees from that nominal direction, when the strip is viewed from any direction perpendicular to the strip direction. The term “nominal direction” may also refer to the average of the fiber's direction as found using high magnification imaging as described herein.

In some examples, the nominal direction of the texturized protein fibers or sheets within a segment of a strip is generally parallel to the long dimensions of the strip for at least 80%, preferably 95% and preferably 99% of the strips.

The fibers within a strip can be arranged as a single or a plurality of distinct bundles. In accordance with some examples the protein fibers within the strips are elongated fibers.

In some examples, the fibers are aligned within a strip, the structural alignment of the fibers can be obtained by methods known in the art, including extrusion of protein containing material, kneading (for example pulling wheat-gluten containing dough), spinning the protein containing material (e.g. wet spinning or electrospinning of protein material), applying shear forces and heat in other ways such as shear (Couette) cell etc., as will be further discussed below.

The protein material in the strip can be presented in any structurally organized (i.e. texturized) form.

In some other examples, the protein material in the strip can be present in a form of vesicles.

In yet some other examples, the protein material in the strip is present in a form of a polymeric matrix holding the protein material.

Yet, in some examples, the protein material in the strip is present in a form of an emulsion and/or dispersion.

Yet further, in some examples, the protein material in the strip is present in a form of a protein-based Gel.

In some examples, the protein material comprises denatured protein. Denatured protein can be of the kind obtained by methods known in the art, that would lead to protein denaturation and/or protein filament alignment and creation of fibers or ‘sheet-like’ structures. Without being limited thereto, the denatured proteins can be of a kind obtained by applying mechanical forces (e.g. in processes such as: spinning, agitating, shaking, shearing, pressure, application of turbulence, impingement, confluence, beating, friction, wave), radiation (e.g. microwave, electromagnetic), thermal energy (heating - by steam or otherwise), cross-linking, enzymatic reaction (e.g. transglutaminase activity) and chemical reagents (e.g. pH adjusting agents, kosmotropic salts, chaotropic salts, gypsum, surfactants, emulsifiers, fatty acids, amino acids).

The protein can be of a variety of sources that are acceptable and safe for human use or consumption.

In some examples, the protein is plant derived (e.g. isolate or concentrate) or comprises plant derived edible protein(s) and/or peptide(s) and/or amino acids.

The protein material can include one or more proteins in combination with other non-protein

material, e.g. fat. Yet, even if fat is included, the protein constitutes the majority of the protein material as further discussed below.

Without being limited thereto, the plant source for the protein can be any one or combination of soy, wheat, legume (pulses, beans, peas, lentils, nuts), plant seeds and grains (e.g. sunflower, canola, rice), stem or tuber protein (e.g. potato protein), rapeseed and corn.

In some examples, the protein is derived from legume. Specific, yet non-limiting examples of legume/bean proteins include, soy protein, pea protein, chickpea protein, lupine protein, mung-bean protein, kidney bean protein, black bean protein, alfalfa protein.

Some specific, yet not limiting, proteins suitable for meat analogues are beta-gonglycinin, glycinin, vicilin, legumin, albumins, globulins, glutelins, gluten, gliadins, glutenins, mycoproteins.

In some examples, the protein can be derived from sources other than plants, such as algae, fungi (e.g. yeast), bacteria and microorganisms in general.

In some examples, the protein material is of non-mammal source.

In yet another example, part of the protein material can contain animal derived components, e.g. beef muscle, chicken muscle fibers, insect based protein powders, etc., or achieved by means of cell culture, even if the source of the cell is from animal.

Yet, a preferred example is one that lacks mammal-or animal-derived components (excluding components obtained from cell culture).

The proteins can be in the form of a pure protein, a protein isolate, protein concentrate, protein flour, texturized protein such as texturized vegetable protein (TVP).

In some examples, the packed protein unit comprises texturized vegetable protein (TVP). TVP is known in the art to be used as a meat extender or vegetarian meat and is usually created by extruding protein isolates or concentrates using high shear, pressure and heat, from vegetable sources such as wheat, pea and others. TVP is commercially available in different sizes from large chunks to small flaks.

In the context of the present disclosure, TVP is used to denote both dry form of texturized vegetable protein (sometimes regarded to as expanded TVP), as well as high moisture form, known in the art as the outcome of high moisture extrusion (HME) or high moisture extrusion cooking (HMEC) or similarly. TVP may also denote any “intermediate” form of texturized vegetable protein, in which the moisture level in the TVP and/or the degree of expansion of the TVP is intermediate between those typically found in dry (expanded) form and HME(C) form.

In some examples, the packed protein unit comprises gluten, which is known to form fibrous structure in its native form, by plain hydration. Without being bound by theory, such gluten-based fibers may be aligned into a certain direction by pulling or pushing through a printing nozzle.

The protein strip(s) in the packed protein unit can include a single protein or a combination of proteins.

The packed protein unit can include substances other than the protein material.

In the context of the present disclosure, the protein strips of the packed protein unit comprises at least 30% protein, and yet in some preferred examples, the protein strand comprises at least 35%, at least 40%, at least 45%, at least 50%, at least 55%, at least 60%, at least 70% or even at least 80% protein material.

In some examples, the strips in the packed protein unit are free of fat.

In some other examples, the strips in the packed protein contain fat, e.g. to modulate the rheological properties, e.g. flexibility of the packed protein strips.

The strips in the packed protein unit can include other edible additives, such as, without being limited thereto, fibers originating from either protein and/or carbohydrate origin, including without limitation starches and dietary nutritional fibers (and other forms of cellulose-based fibers); colorants (e.g. annatto extract, caramel, elderberry extract, lycopene, paprika, turmeric, spirulina extract, carotenoids, chlorophyllin, anthocyanins, and betanin), emulsifiers, acidulants (e.g. vinegar, lactic acid, citric acid, tartaric acid malic acid, and fumaric acid), flavoring agents or flavoring enhancing agents (e.g. monosodium glutamate), antioxidants (e.g. ascorbic acid, rosemary extract, aspalathin, quercetin, and various tocopherols), dietary fortifying agents (e.g. amino acids, vitamins and minerals), preservatives, stabilizers, sweeteners, gelling agents, thickeners and dietary fibers (e.g. fibers originating from citrus source).

The packed protein unit can contain different protein strips so as to provide different portions of the food product, e.g. meat analogue with a different mouthfeel or experience.

The protein strips may be coated or wrapped or covered or enveloped or enclosed, even partially with functional material. Coating can be partial coating such that portions of the outer surface of the strips are covered by the functional material, or coating can be complete coating, where the entire outer surface of the strips are covered with the functional material.

In the context of the present disclosure, the term “functional material” encompasses any substance bestowing a physical or chemical property to the strip. The functional material can be in a form of a powder, a film or a liquid associated with one or more portions of the outer surface of said one or more strips.

In some examples, the functional material is selected to at least prevent or reduce adherence between adjacent strips, e.g. non-stick surface that will prevent adjacent strands from sticking to each other while packed in or by the retaining element. Without being limited thereto, such substances can include cellulose based, such as methylcellulose (e.g. in the form of powder), crystalline methylcellulose (CMC), alginate, pectin; anti-caking agents; Zein powder; edible mineral powder, hydrocolloids, gluten powder etc. such substances can also be used to strengthen the strips.

In some other examples, the functional material is a non-edible, yet food safe plastic materials, such as polyethylene, polypropylene, nylon or other types of film membrane/food packaging materials. In the case of non-edible coating, these would typically be removed before printing. Removing can be by mechanical peeling, chemically (e.g. dissolving) and/or by melting.

In some other examples, the functional material can be one or more substances selected to improve texture of the strip. In one example, the functional material is selected to improve flexibility of the strip. Without being limited thereto, such substances can include water, a gelling agent, an adhesive material, and further, as non-limiting examples, oil or at times, as non-limiting examples starch, alginate, wax, cellulose.

In yet some other examples, the functional material is one that protects the protein material from oxidation, e.g. when the texturized protein is hydrated or even partially hydrated and therefore more prone to oxidative damage. Without being limited thereto, such anti-oxidative coating material can include food safe-polymers.

In yet some other examples, the functional material is a bacterial protectant, namely, prevents/blocks bacterial growth on the strips, e.g. when the texturized protein is hydrated or even partially hydrated and therefore more prone to bacterial contamination.

In some examples, the functional material is a hydrating/moisturizing material, used to moisture or increase water content at least at the surface of the strip. Without being limited thereto, such moisturizing material is or comprise water.

In some examples, the functional material is an edible material that remains associated with the protein material and forms part of the final mean analogue product.

In some examples, the functional material is an adhesive precursor, namely, a material that when the protein is in a packed state, is inert, and can be activated to act as an adhesive, e.g. when hydrated/brought into contact with water. For example, the functional material can comprise starch and/or gluten that once wetted, becomes sticky and acts as an adhesive.

In some examples, the functional material applied onto strips is a binding agent.

In the context of the present invention a binding agent is any substance that contributes to the integrity of the fabricated meat analogue product, i.e. to ensure and/or maintain the product's cohesiveness and/or structural stability.

Cohesiveness describes how well a food retains its form between the 1^{st} and 2^{nd} chew. This Cohesiveness value is directly related to the tensile and compression strength of the meat analogue product. For example, meats have high cohesiveness while, for example, peaches have low cohesiveness properties.

In some examples, the binding agent is any one or combination of gluten, such as wheat gluten, egg whites, gums and hydrocolloids, enzymes, cross-linking gelling agents and starches.

In some examples, the enzymes are of a type that catalyze the formation of disulfide bonds and/or isopeptide bonds. In some examples, the enzyme is transglutaminase.

In some examples the binding agent comprises a hydrocolloid. Hydrocolloids are already used in meat products to improve functional properties and at times compensate undesirable effects of fat reduction, salt reduction and freeze/thaw processes.

The hydrocolloid employed in the context of the present disclosure can contain a single type of hydrocolloid such as, and without being limited thereto, carrageenan, alginate (e.g. calcium alginate), konjac gum, flaxeed gum, or locust bean gum.

In some examples, the hydrocolloids are formed of a combination of substances, creating synergy, such as those listed above.

The protein strip(s) can be treated with a functional material at different stages. In some cases, the protein strips are treated prior to packing, in some other cases, the protein strips are treated prior to placement onto an additive manufacturing bed. In yet some other cases, the protein strips(s) are treated with a functional material after being placed onto the bed. Treatment of the protein strips already placed on the bed can be during formation of a monolayer, after a layer is formed, and/or after several layers are formed. The functional material can be activated when in contract with the strips, e.g. by inducing cross linking. In some cases, e.g. when the functional coating comprises wheat protein, activation into a sticky coat can be achieved by spraying the strips with water, causing formation of ‘sticky’ gluten coating.

In some examples, at least a portion of the circumference of the protein strip is mechanically treated to improve bonding between the strips once the food product is fabricated, as further discussed below.

To allow the long-term storage stability of the strips in the packed protein unit, it is preferable that the protein strip be essentially dry. When referring to an essentially dry protein strip it is to be understood as encompassing protein material that contains up to 15% (v/v) water, at times, up to 10% water, at times, up to 5% water, and at times, less than 1% water.

In some examples, the strips in a packed protein unit are semi-dry, namely, includes up to 25% v/v water, and at times, between 15% to 25% v/v water.

The dry protein strips can be obtained by various drying methods known in the art. In some examples, the dry protein strip is obtained by freeze drying of the strips. In some other examples, the dry protein strip is obtained by inert gas drying [K. Sanjeev & M. N. Ramesh (2006) Low Oxygen and Inert Gas Processing of Foods, Critical Reviews in Food Science and Nutrition, 46:5, 423-451, DOI: 10.1080/10408390500215670].

The manner of packing can, at times, dictate the level of dryness. For example, when the packed protein unit is in the form of a plurality of essentially straight strips parallelly stacked one on top of the other (somewhat resembling matches within a matchbox), the plurality of strips can be rigid and/or essentially completely dry. Further, for example, when the packed protein unit contains the strip in a convoluted configuration, it may be necessary to maintain some flexibility of the strip, which may necessitate a minor level of moisture. Alternatively, flexibility can be achieved by adding some level of oil or other additives, e.g. softening agent, such as gums.

To further ensure the long-term stability of the one or more texturized protein strips of the packed protein unit can be maintained under inert atmosphere at times, referred to as an oxygen-less atmosphere. Without being limited thereto, inert atmosphere/conditions can be obtained by any means of vacuum environment, inert gas atmosphere (typically referring to gaseous mixture that contains little or no oxygen and primarily consists of non-reactive gases or gases that have a high threshold before they react, such as Nitrogen, Argon, Helium, and Carbon dioxide).

To yet further ensure long-term stability, in some examples, the one or more texturized protein strips are sterilized and/or combined with food grade preservation agents. Examples of preservation agents include, without being limited thereto, pH adjusting agent (selected to lower the pH of the food product below 6), salt. In addition, or alternatively, sterilization can be by thermal and/or UV or other radiation means.

In some examples, to obtain the single or multi-layer food product, a strip of the protein is applied over printing bed in a manner that a single convoluted strand or a plurality of individual strands are laid onto or placed onto the printing bed with segments between folds of the single strand or between the plurality of strands being preferentially essentially parallel along their longitudinal axis.

In this manner and in accordance with principles of digital printing, a multiplicity of monolayers of strands are formed into a 3D food product.

In some other examples, to obtain the single or multi-layer food product, a strip of the protein is applied in accordance with other principles of additive manufacturing techniques, not necessarily based on 3D printing. This may include, for example, the use of robotics to sequentially place the strips one on top of the other according to a pre-defined plan.

The fabricated food product, e.g. the meat analogue product, can comprise a combination of materials, and not only the protein strips released from the packed protein unit. The combination of materials can be achieved, for example, by using a combination of printing heads, operated according to a predefined printing pattern/print assembly plan, as described in PCT/IL2020/050099, the content of which is incorporated herein by reference.

In some examples, the additional components are fat-based material. In the context of the present disclosure, when referring to a fat-based material it is to be understood as a composition comprising any type of food acceptable fat or fat-like component used as fat alternative in the food industry.

The fat-based material can be incorporated into the food product as it is fabricated, e.g. via a dedicated and distinct printing head (as a fat-based strand) or introduced by spraying, or dipping the bed holding the released protein material with the fat-based material.

The meat analogue can also be formed by combining the protein material and optionally the fat-based material with a water-based or aqueous-based or moisture-providing material. The water-based material comprises water solutions or water-based gels carrying various solutes and/or suspended/dispersed material such as colorants, salts, thickening agents, fillers, stabilizers, emulsifiers, etc.

In some examples, the water-based material is in a form of a gel at temperatures in the range of 15° C. to 80° C., at times, in the range of 20° C. to 65° C.

In some examples, the water-based component comprises any one or combination of edible additives, such as colorants, emulsifiers, stabilizers, acidulants, flavoring agents, thickening agents, antioxidants, dietary fortifying agents, preservatives, vitamins, sweeteners, all known to those versed in the art.

In some examples, the protein strips are combined with any one or combination of modified starch, maltodextrin, agar, each acting as the water-based material, modified starch.

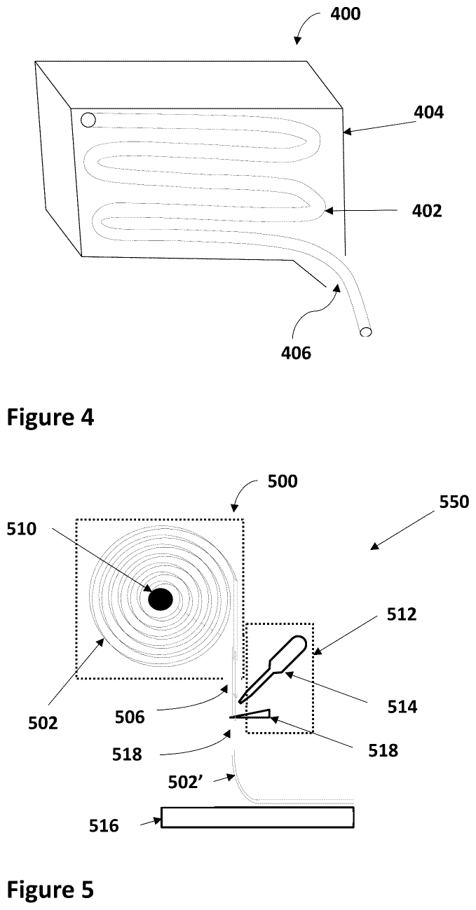

The water containing material can be applied onto the fabricated layers by any technique available, including spraying, e.g. via a material applicator such as applicator 414 in FIG. 4, or even by dipping.

The meat analogue product can be constructed from different protein materials that are separately applied onto an additive manufacturing bed, e.g. from different printing heads or printing tips in a 3D printer. To facilitate the combination of different protein strips, the present disclosure also provides sets of packed protein units, each unit comprises elongated texturized protein strips held by or within a retaining element the at least one elongated texturized protein strip being defined by a longitudinal axis and a cross sectional area taken perpendicular to the longitudinal axis; wherein at least one dimension of said cross sectional area is equal or less than 10 mm and said longitudinal axis has a dimension of at least 100 mm, and wherein the elongated texturized protein strips within at least some of the units of the set is different from the elongated texturized protein strips within other units within the set.

The difference between two units of a set can be by any chemical and/or physical parameter. In some cases, the difference is at least in one of dimensions and/or texture and/or composition of the texturized protein strips.

More specifically, and yet, without being limited thereto, difference in the protein strips between packed protein units within a set can be exhibited by any one of the following:
difference in the composition of the components, e.g. in the types and or degree of purity of proteins included within the different packed protein units and/or in the amounts of proteins included within the different packed protein units (even if the same proteins are used among the different units in a single set of units),
difference in the texture of the protein in the different packed protein units such that for example, some packed protein units within a set can be highly texturized (preferably fibrous, preferably substantially aligned fibrous) and some less texturized, so they exhibit different textural behavior.
Differences in porosity of the protein strains in different packed protein units, which may contribute or affect the protein's water holding capacity.
difference in the form of the protein in the packed protein units such that some protein within a unit can be in the form of a gel and some others, within units of the same set of units, can be in the form of a dough and/or an emulsion.

The present disclosure also provides a method of fabricating a meat analogue product, the method comprises:
providing at least one packed protein unit comprising at least one elongated texturized protein strip held, in an organized configuration, by or within a retaining element, the at least one elongated texturized protein strip being defined by a longitudinal axis and a cross sectional area taken perpendicular to the longitudinal axis; and
releasing onto a food fabrication bed one or more texturized protein strips from said at least packed protein unit to form one or more monolayers of texturized protein strands;
   wherein at least one dimension of said cross sectional area is equal or less than 10 mm and said longitudinal axis has a dimension of at least 100 mm;
   wherein said release is in a manner to cause, in a monolayer, alignment along a predefined direction of at least 60% of the plurality of texturized protein strips; and
   wherein said release of the at least one texturized protein strip is in a manner to form on the food fabrication bed a multi-layered meat analogue product, where each layer is being created essentially one on top of the other.

In the context of the present disclosure, when referring to a layer, e.g. in a set of layers formed one on top of another as done, for example, in additive manufacturing methods, such as in a 3D multi-layer structure, it is to be understood that the layer can be a full layer, i.e. extending on the entire surface of the previously formed layer (onto which it is placed), or a partial layer, e.g. occupying only a portion or portions of the previously formed layer, or even a single strand placed on top of a previously formed layer.

The protein strips can be released from the retaining element in various manners, at times, depending on the packaging configuration.

In some examples, the texturized protein strip is released from the retaining unit by unrolling or unwinding at least one elongated texturized protein strips being, respectively rolled or spirally wound over a central body.

In some other examples, the texturized protein strip is released by dispensing individual strips from the retaining element.

In yet some other examples, the texturized protein strips are release by the air or a dedicated robotic arm, lifting or pulling strips from the unit.

In some examples, the one or more elongated texturized protein strips are hydrated prior to, during or after being released from said packed protein unit. Hydration can be achieved by the use of a dedicated applicator, such as the treatment applicator described in the non-limiting examples. In some examples, the one or more elongated texturized protein strips are hydrated immediately before placing onto the food fabrication bed.

In some examples, the method disclosed herein comprises cutting a strip during or after the release of the strip from the packed protein unit. The cutting/slicing is typically remote from the food fabrication bed such that once a cut is formed and a strip edge is formed, the edge is dropped onto the bed (in a controlled manner).

In some examples, the method comprises cutting and/or slicing and/or pinching (pinching sections of the strip to cause surface curvature without disrupting the continuity of the strip) at least some of the strips during their release from their retaining element to obtain strip fragments and aligning the strip fragments onto the food fabrication bed in an essentially parallel manner.

In some cases, the cutting/slicing is in a manner providing strip fragments of same or similar dimensions.

Further, the method disclosed herein comprises treating the released texturized protein strips or strip fragments (depending on how the protein material is packed) prior to or shortly after being placed onto the food fabrication bed, the treatment comprises applying functional material onto at least a portion of the one or more texturized protein strips or strip fragments.

In some examples, the method comprises treating the one or more texturized protein strips or strip fragments prior to or shortly after being placed onto said food fabrication bed, by removing material from at least a portion of the one or more texturized protein strips.

The method provides meat analogue product with one or more layers of protein strips. In some preferred cases, the method comprises creating on the bed a plurality of layers, being positioned essentially one on top of another. The layers can comprise the same or different protein composition, as described hereinabove. Thus, in some cases, the multi-layer product can comprise a plurality of layers formed of strips of different protein composition and/or different strip shape and/or dimensions.

The method can also comprise one or more applications of other materials within or onto a layer. For example, the method can comprise applying fat material onto at least a portion of released protein strips. Further, for example, the method can comprise applying additives onto at least a portion of the released protein strips. Examples of additives may include, without being limited thereto, hydrocolloids, water-based formulations (e.g. such as those used as blood substitutes), flavors, coloring agents, etc.

As used herein, the forms “a”, “an” and “the” include singular as well as plural references unless the context clearly dictates otherwise.

Further, as used herein, the term “comprising” is intended to mean that, for example, a component, e.g. a protein strip includes the recited protein, but not excluding other substances including other proteins. The term “consisting essentially of” is used to define, for example, protein strip which includes proteins but exclude other substances that may have an essential significance on the characteristics of the resulting food product. “Consisting of” shall thus mean excluding more than trace amounts of other elements. Embodiments defined by each of these transition terms are within the scope of this disclosure.

Further, all numerical values, e.g. when referring the amounts or ranges of the elements constituting the component disclosed herein, are approximations which are varied (+) or (−) by up to 20%, at times by up to 10% of from the stated values. It is to be understood, even if not always explicitly stated that all numerical designations are preceded by the term “about”.

Further, as used herein, the term “percent”, or “%”, refers to percent by weight, unless specifically indicated otherwise.

The invention will now be exemplified in the following description of experiments that were carried out in accordance with the invention. It is to be understood that these examples are intended to be in the nature of illustration rather than of limitation. Obviously, many modifications and variations of these examples are possible in light of the above teaching. It is therefore, to be understood that within the scope of the appended claims, the invention may be practiced otherwise, in a myriad of possible ways, than as specifically described hereinbelow.

### NON-LIMITING EXAMPLES

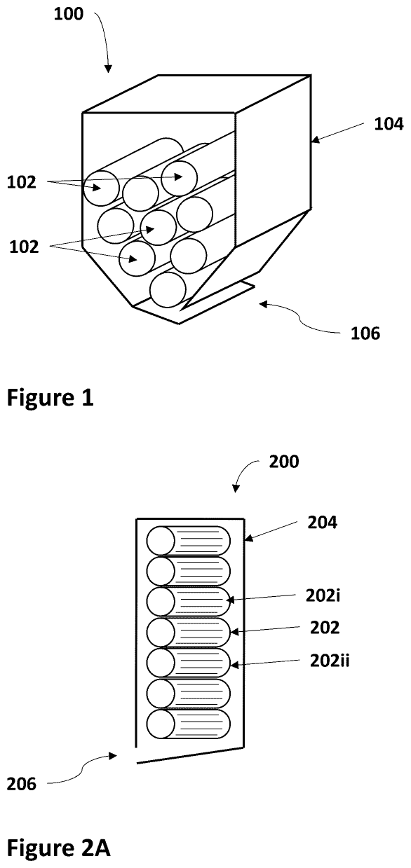

Reference is now made to FIG. 1 illustrating packed protein unit 100 in accordance with some examples of the present disclosure. The packed protein unit 100 comprises a plurality of discrete and separable strands 102 within a holding element, illustrated herein as cartridge 104. The cartridge 104 has an outlet 106 in a form of an elongated opening parallel to the longitudinal axis of the essentially aligned strands 102. The configuration of outlet 106 permit the release of each strand 102 from the cartridge 104 as an individual strand.

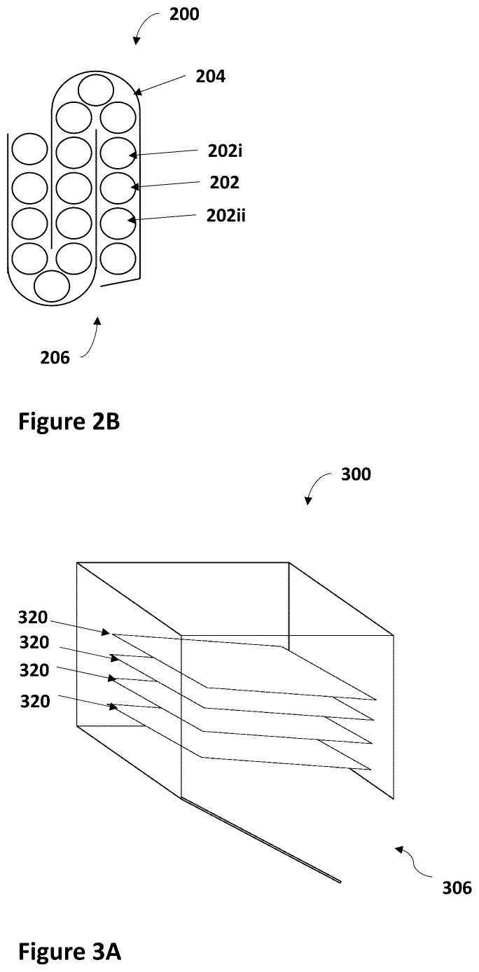

Alternative configurations for packing protein strands are illustrated in FIGS. 2A-2B.

For simplicity, like reference numerals to those used in FIG. 1, shifted by 100 are used in FIGS. 2A-2B to identify components having a similar function. For example, component 202 in FIGS. 2A-2B is a short strand having the same function as strand 102 in FIG. 1.

FIGS. 2A-2B illustrate packed protein unit 200 including discrete and separable protein strands 202 columned one on top of the other within a cartridge 204. The dimensions of the cartridge 204 are such that each strand has a single upstream strand, such as strand 202i and a single downstream strand, such as strand 202ii. Cartridge 204 has an outlet 206 in a form of an elongated opening parallel to the longitudinal axis of the columned strands 202. The configuration of outlet 206 permit the release of each strand 202 from the cartridge 204 as an individual strand.

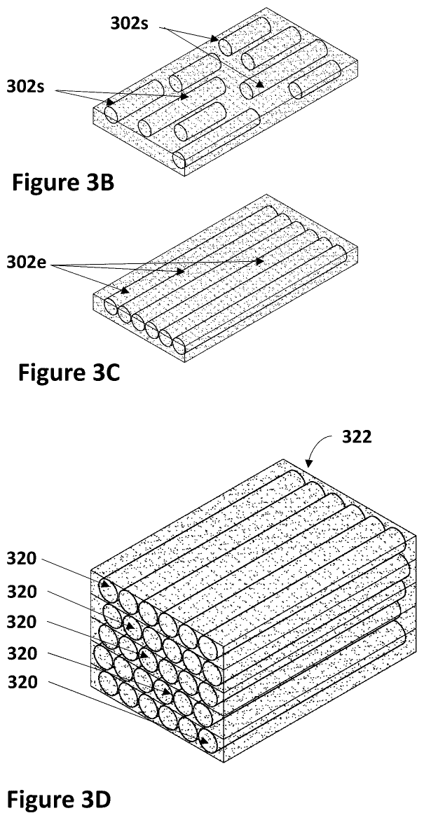

FIG. 3A-3D provide schematic illustrations of packed protein unit 300, as a set of stacked sheet-like structures 320, each sheet formed form an organized collection of strands 302.

Each sheet like structure 320 can be composed of strands 302s of texturized protein of a first dimension, as shown in FIG. 3B or from extra elongated strands 302e of texturized protein as shown in FIG. 3C. In this connection it is noted that the 302s or 302e are illustrated as strands of the same dimensions, e.g. length, it is not necessary that in a single sheet the strands are identical in their dimensions.

The strands or sheet like structures are released as individuals (each time a single strand or sheet is released), yet in some cases, it may be desired that a group of strands or sheets are released, in the latter case, similar, to some extent, to squares of Puff Pastry.

In some examples, as also schematically illustrated in FIG. 3D, the sheet like structures (320) are a priori staked into a multi-layered unit 322 and this multi-layer unit 322 is then released as a single layer from the opening 306.

FIG. 4 illustrates packed protein unit 400 including an elongated protein strand 402 folded within cartridge 404 in a convoluted configuration. Cartridge 404 has an outlet 406 having a shape that conforms with the circumference of the elongated protein strand 402, allowing the continuous flow of strand 402 through outlet 406.

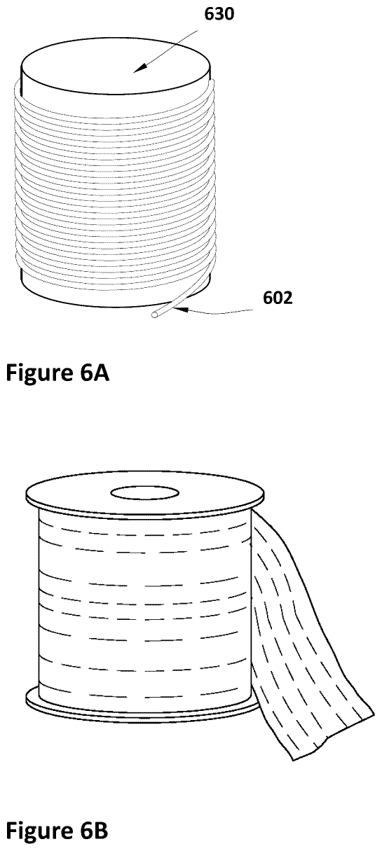

FIG. 5 illustrates elements of a food fabrication system 550 for fabrication of food, such as a meat analogue according to the present disclosure, making use of packed protein units according to some examples of the present disclosure.

For simplicity, like reference numerals to those used in FIG. 4, shifted by 100 are used in FIG. 5 to identify components having a similar function. For example, component 502 in FIG. 5 is an elongated strand having the same function as elongated strand 302 in FIG. 3.

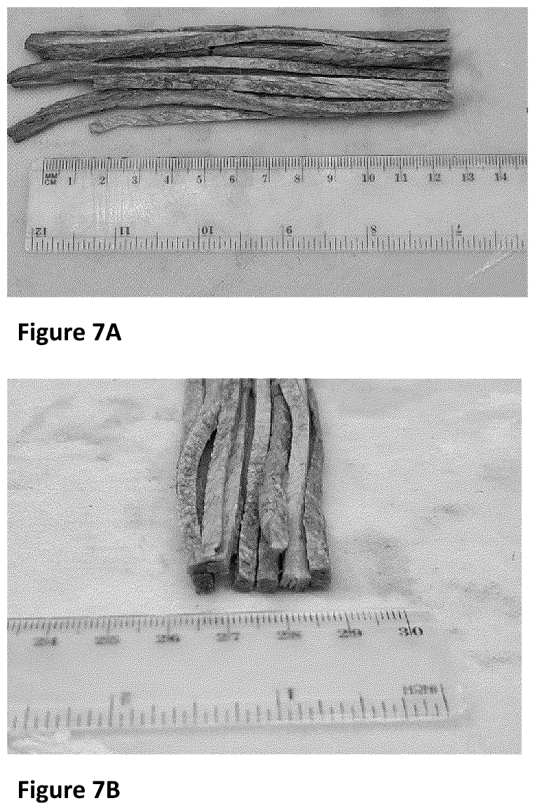

Specifically, food fabrication system 550 illustrates packed protein unit 500 including an elongated protein strand 502 within cartridge 504 wounded around a central body 510 in a spiral configuration. In some examples, a protein strand 502 can be rolled/spirally wounded over a spool 530 as illustrated in FIGS. 6A-6B.

Cartridge 504 has an outlet 506 allowing the continuous outflow of strand 502 from cartridge 504.

Further, food fabrication system 550 illustrates a printing head 512 including a treatment applicator 514 for applying onto strand 502 functional material once released from cartridge 504 and before being placed onto printing bed 516. Treatment applicator 514 can include, for example, a functional material can be water that is sprayed onto strand 502 so as to add moisture and thereby soften the strand before being manipulated onto printing bed 516. Further, for example, the function material can be a solvent, an anti-stick agent, etc.

In some examples, treatment applicator 514 can be a heater/cooling unit for, respectively, heating or cooling the existing protein strand.

Further, in some examples, treatment applicator 514 can be a laser unit e.g. for inducing cross-linking within existing protein strand and/or for participating in the slicing of a released strand.

In some examples, an additional applicator can be used (not illustrated) to apply materials other than the functional material, for example, to apply onto the printed layer a water-based material and/or fat-based material as described hereinabove.

Printer head 512 also includes a cutter 518 which can be in a form of a blade, for release from cartridge 500, a printed strand 502′ onto bed 512.

Food fabrication system 550 typically also comprises a control unit (not illustrated) for controlling, inter alia, rate of release of strand 502 from cartridge 504, direction of placement of strand 502 onto printing bed 516, movement of printing bed 516, operation of treatment applicator 514 and activation of cutter 518. In some examples, the control unit controls rotation of central body 510 whereby protein strand 502 from cartridge 504 is released according to the rotation rate of the central body. Alternatively, the control unit can control operation of pulling arm that pulls protein strand from the cartridge (also not illustrated).

In operation, fabrication of the food product and preferably meat analogue is obtained by the controlled placement of one or more protein strands 502′ onto food fabrication bed 516. The fabrication can involve movement of dispensing head with respect to the food fabrication bed, movement of the dispensing bed with respect to the dispensing head, or both (simultaneous or sequential movement of both).

The meat analogue product is obtained by alignment of one or more protein strands, such as strands 502′ over food fabricating bed 516 and once a monolayer with a predefined pattern is fabricated, repeating the monolayer formation process layer by layer, until a multi-layered food product is obtained.

In some examples, the placement of the released protein strand can be achieved by the use of a dedicated robotic arm (not illustrated).

Turning now to FIGS. 6A-6B there are illustrated two forms of packed protein units 600, in each case the texturized protein material is wounded over a spool 630, in FIG. 6A, the texturized protein material is in a form of an elongated, spirally wounded thread 602, while in FIG. 6B the texturized protein material has a wider cross section (the cross section A perpendicular to the longitudinal axis of the strand) of the strand in FIG. 6A, and thus may resemble an elongated spirally wounded ribbon or film.

### Example—TVP Protein Strands

For illustration of packed texturized protein units in accordance with the present disclosure, commercial dry TVP sheets were immersed in water with colorants and flavors and then excess of water was squeezed out. The wetted TVP was then sliced into thin sheets of not more than 3 mm. Each thinned sheet was then sliced in a slicing machine into strands of the desired dimension.

FIGS. 7A-7B provide images of the sliced strands and their dimensions, being between 100 mm and 130 mm long (FIG. 7A) and having a 4 mm*4 mm cross section (FIG. 7B).

The elongated strand can have dimensions of even 1 m and then be rolled over a support structure as illustrated in FIG. 7C.

FIG. 7D provides a closer look at the internal texture/morphology of the strand, clearly showing it to be porous/spongy with voids that can accommodate fluid additives, such water based components, fat based components and others. It is noted that when referring to the cross sectional area, it includes the area within an imaginary line marking the boundaries of the strand, such as the square boundary marked in FIG. 7D irrespective of whether the TVP is porous.

1. A method of fabricating a meat analogue product, the method comprising:
providing at least one packed protein unit comprising at least one elongated texturized protein strip held, in an organized spatial configuration, by or within a retaining element, the at least one elongated texturized protein strip being defined by a longitudinal axis and a cross sectional area taken perpendicular to the longitudinal axis; and
releasing onto a food fabrication bed one or more texturized protein strips from said at least one packed protein unit to form one or more monolayers of texturized protein strips;
wherein at least one dimension of said cross sectional area is equal or less than 10 mm and said longitudinal axis has a dimension of at least 100 mm;
wherein said release is in a manner to cause, in a monolayer, alignment along a predefined direction of at least 60% of the plurality of texturized protein strips; and
wherein said release of elongated texturized protein strips is in a manner to form on the food fabrication bed a multi-layered meat analogue product, where each monolayer is being created essentially one on top of the other.

2. The method of claim 1, wherein said at least one elongated texturized protein strip is hydrated prior to, during or after being released from said packed protein unit.

3. The method of claim 1, further comprising slicing at least part of the elongated texturized protein strip during its release from packed protein unit to obtain strip fragments and aligning the strip fragments onto the food fabrication bed in an essentially parallel manner.

4. The method of claim 3, wherein said slicing is in a manner providing strip fragments of same or similar dimensions.

5. The method of claim 1, further comprising treating released texturized protein strips or strip fragments prior to or shortly after being placed onto said food fabrication bed, said treatment comprises applying functional material onto at least a portion of the texturized protein strips or strip fragments.

6. The method of claim 1, further comprising treating the at least one texturized protein strip or strip fragments prior to or shortly after being placed onto said food fabrication bed, said treatment comprises removing material from at least a portion of the texturized protein strips or strip fragments.

7. The method of claim 1, further comprising releasing from the packed protein unit a texturized protein strip by unrolling or unwinding at least one elongated texturized protein strips being, respectively rolled or spirally wound over a central body and fabricating at least one monolayer from released elongated texturized protein strip, and cutting the released strip once a monolayer is formed.

8. The method of claim 1, wherein the elongated texturized protein strip is released from a cartridge through an elongated outlet oriented substantially parallel to the longitudinal axis of the strip.

9. The method of claim 1, further comprising fabricating a plurality of monolayers, one being positioned on top of another.

10. The method of claim 1, wherein at least 80% of the elongated texturized protein strips within a monolayer are aligned substantially parallel to one another.

11. The method of claim 1, wherein said multi-layer food product comprises a plurality of monolayers comprising a plurality of texturized protein strips of different protein composition and/or different dimensions.

12. The method of claim 1, further comprising applying fat component or additive onto at least a portion of said released protein strips.

13. The method of claim 1, further comprising applying additives onto at least a portion of said released protein strips.

14. The method of claim 1, wherein the at least one packed protein unit includes two or more packed protein units, said two or more units being different of in at least one of strips dimensions and/or strips texture and/or strips porosity and/or strips composition.

15. The method of claim 14, wherein the packed protein units differ in protein composition.

16. The method of claim 14, wherein the packed protein units differ in strip texture.

17. The method of claim 14, wherein the packed protein units differ in strip porosity.
